(19) United States
(12) Patent Application Publication
(10) Pub. No.: US 2012/0239618 A1
(43) Pub. Date: Sep. 20, 2012

(54) FILE SHARING MECHANISM

(75) Inventor: Gary Kung, Santa Ana, CA (US)

(73) Assignee: I O INTERCONNECT, LTD., Santa Ana, CA (US)

(21) Appl. No.: 13/232,793

(22) Filed: Sep. 14, 2011

Related U.S. Application Data
(60) Provisional application No. 61/453,366, filed on Mar. 16, 2011.

(51) Int. Cl. G06F 17/30

(52) U.S. Cl. 707/621; 707/E17.01

(57) ABSTRACT

An embodiment of the invention provides a data sharing method for a portable device. The method comprises executing an application program to create a data sharing event by a first user, and creating a user list by the first user, wherein when a second user of the user list shares a first file via the data sharing event, the first user receives and stores the first file in the portable device.

### CROSS REFERENCE TO RELATED APPLICATIONS

This application claims the benefit of U.S. Provisional Application No. 61/453,366 filed Mar. 16, 2011, the entirety of which is incorporated by reference herein.

### BACKGROUND OF THE INVENTION

1. Field of the Invention

The present disclosure provides a file sharing mechanism, especially to a real time file sharing mechanism

2. Description of the Related Art

File sharing has been a feature of networked computer systems for many years. Computer networks allow one to share files with friends, family, co-workers and customers. Before the Internet and home networks became popular, files were often shared using floppy disks. Nowadays, some people still use CD-ROM/DVD-ROM disks and USB keys for transporting their photos and videos, but networks allow more flexible options.

### BRIEF SUMMARY OF THE INVENTION

An embodiment of the invention provides a data sharing method for a portable device. The method comprises: executing an application program to create a data sharing event by a first user; and creating a user list by the first user, wherein when a second user of the user list shares a first file via the data sharing event, the first user receives and stores the first file in the portable device.

Another embodiment of the invention provides a data sharing method. The method comprises: creating a data sharing event; linking the data sharing event to a social network service; generating a user list; verifying and determining whether a first portable device is included in the user list; allowing the first portable device to join the data sharing event when the first portable device is included in the user list and passes a verification procedure; when receiving a first file from the first portable device, uploading the first file to the social network service.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of an embodiment of a system implementing the proposed file sharing mechanism according to the invention.

FIG. 2 is a schematic diagram of an embodiment of the file sharing mechanism according to the invention.

FIG. 3 is a schematic diagram of another embodiment of the file sharing mechanism according to the invention.

FIG. 4 is a flowchart of an embodiment of a file sharing method according to the invention.

FIG. 5 is a flowchart of another embodiment of the file sharing embodiment according to the invention.

FIG. 6 is a block diagram of an embodiment of a portable device with the described file sharing mechanism according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present innovation provides a file sharing method that allows multiple users to upload data or files, such as photos, to a destination device, website, blog or social network service, wherein the users can also see the uploaded files via a human machine interface or an application program.

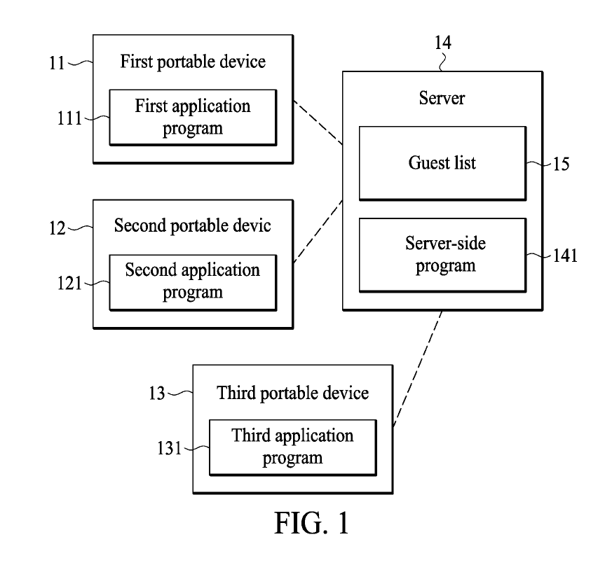

FIG. 1 is a schematic diagram of an embodiment of a system implementing the proposed file sharing mechanism according to the invention. The system of FIG. 1 comprises a first portable device 11, a second portable device 12, a third portable device 13, a server 14 and a guest list 15. In another example of the file sharing mechanism, the guest list 15 is integrated with the server 14. The first portable device 11 may be a smart phone, a PDA, a laptop, a tablet, a PDA phone, and a digital camera with Bluetooth, Wi-Fi or other wireless transmission interface, and other similar portable devices. In another embodiment of the file sharing system, a memory card with a built-in Wi-Fi module can be applied in the digital camera.

The server 14 comprises a server-side program 141 and the server-side program 141 confirms the access right of the first portable device 11, the second portable device 12 and the third portable device 13 according to the guest list 15. The server-side program 141 first generates an access link and a folder corresponding to an event that is created by a user. In other words, a user can use the electronic device that installs the client-side program, which corresponds to the server-side program 141, and executes the client-side program to create an event. When the server-side program 141 receives a user request, the server-side program 141 then generates an access link and a folder corresponding to the event. When a user creates the event, a user can also manually set the guest list 15. The guest list 15 comprises user's name (or other unique ID) and corresponding access right. For example, the first user has both the read and write right to the folder, thus, the first user can upload and download the data in the folder, and the second user only has read right to the folder, thus, the second user can only download the data in the folder. In other embodiments, the user can only see the data via the client-side program and cannot download data from the server 14.

When the first portable device 11 executes the first program 111, a window is shown in a display of the first portable device 11 and a user can see the current data or files stored in the server 14 via the window. In another embodiment, the current data or files are also transmitted to the first portable device 11. The data or files also contain provider information, such as a provider's name, location or caption of the data or files. As to the portable devices 12 and 13, the operation is similar to the portable device and is not described here for brevity.

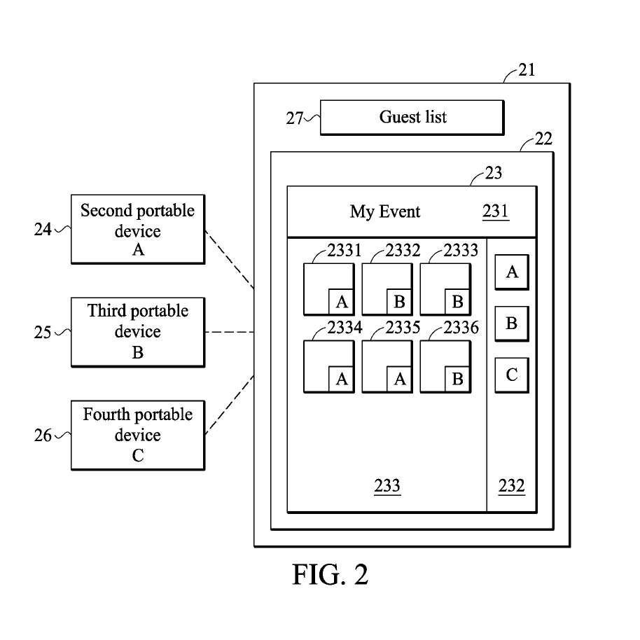

FIG. 2 is a schematic diagram of an embodiment of the file sharing mechanism according to the invention. The first portable device 21 executes a file sharing program and a corresponding window 23 is shown on the display 22. The window 23 comprises three fields. In FIG. 2, the user of the first portable device 21, called a first user in the following paragraphs, announces an event via a file sharing program and sets a guest list and a necessary confirmation configuration. The file sharing program can connect to a server or link to a social network service provider, such as facebook, twitter, plurk or others. In the following paragraphs, the file sharing mechanism illustrated with a server corresponds to the file sharing program.

When the first user announces an event, the first user can set the event name and a guest list 27. The guest list 27 can be generated by several ways and stored in the server. In another embodiment, the guest list 27 is generated from a contact list or a friend list of a social network service provider, the generated guest list 27 is stored in the server of the network service and the guest list 27 can be accessed by the file sharing program. In one example, the first user can manually input the invited guest names. In another example, the file sharing program contains a positioning function that can automatically detect and determine the current location of the first user using the first portable device 21 and transmit and store a first location corresponding to the first user to the server. The file sharing program then searches a location database of the server and finds and sends an invitation to another user having a current location which is the same as the first location to join the event. In another example, the file sharing program can generate a URL link or invitation code corresponding to the event, and the user A can use the second portable device 24 to receive the URL link or the invitation code to join the event. The URL link or the invitation code can be made in a form of a QR code, bar code or 2D code, and the user A uses a decoder of the second portable device 24 to decode the invitation Code, wherein the decoder may be implemented by hardware or replaced by a decoding program that is executed by the controller of the second portable device.

In another example, the positioning function can use the GPS location data if the portable device has a GPS module. The file sharing program can set a circular area with a center from the first user's position, and when the position of the guest is within the circular area and the guest has a portable device with the file sharing program installed therein, an invitation message will be transmitted to the guest's portable device to join the event. Once the guest responds to join the event, the guest's name or the ID of the guest's portable device will be shown in the contact field 232, and the guest can view or read the file shown in content field 233.

The following example is illustrated using a wedding event to describe the operation of the file sharing program.

The user A has a second portable device 24, which is a smart phone with a camera, the user B has a third portable device 25, which is a digital camera with Wi-Fi, and the user C has a fourth portable device, which is a tablet without a camera. The users A, B and C attend the first user's wedding party, and are shown in the contact field 232. When the user A takes photos, the photos will automatically upload to the server and be shown in the content field 233. The first user and users B and C also see the photos on their portable device via the file sharing program and can directly and automatically download the photos from the server. The photos shown in the content field 233 contain the information of provider. For example, if the photo is taken by user A, the file sharing program will label user A in the corner of the photo or when other a user touches the photo, another window containing information of user A is shown. Furthermore, the window can also contain other information, such as date, time, location or EXIF (Exchangeable image file format). Similarly, the photos taken by the user B are also uploaded to the server and the first user, users A and C can also view the photo on their portable device. In another embodiment, user C can set the configuration of the file sharing program and only photos containing user C will be automatically download to the fourth portable device 26, while other photos which are not downloaded in the third portable device 26 can be viewed via the file sharing program.

As to the generation of the guest list 27, the first user can use a scanner to scan the guests' portable device and once the file sharing mechanism or file sharing application program is installed in the guest's portable device, the portable device will be automatically added to the guest list 27. In another embodiment, NFC (Near field communication) devices can be applied to this embodiment. For example, the scanner comprises an NFC controller that can communicate with the portable devices with the NFC apparatus. When the scanner detects that the portable device has the NFC apparatus, the scanner transmits the invitation code or related information to the portable device and the portable device joins the file sharing event according to the received data. The invitation code may be in the form of QR code, bar code or 2D code. In another example, the scanner transmits a link to the portable device, wherein the link leads the user of the portable device to a website to join the file sharing event. The scanner may also receive the user information of the portable device and adds the portable device to the guest list 27.

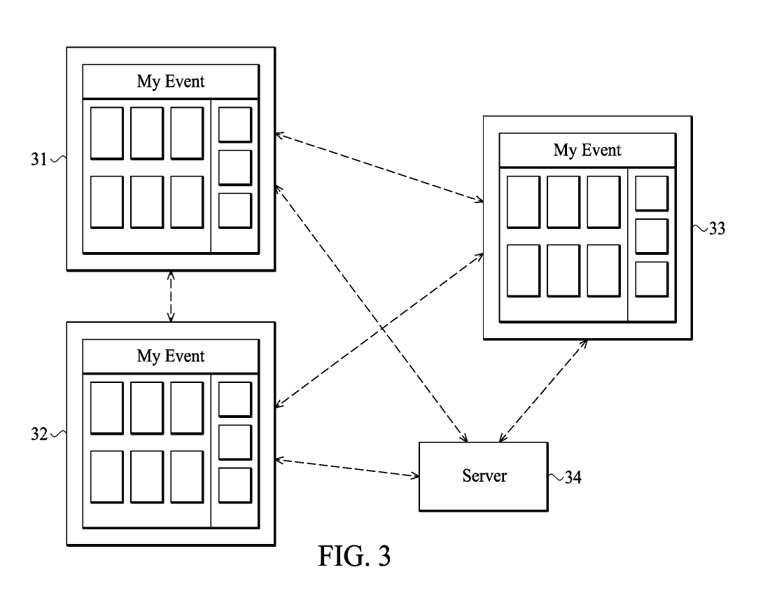

FIG. 3 is a schematic diagram of another embodiment of the file sharing mechanism according to the invention. The portable devices 31, 32 and 33 have an application program called My Event installed therein, along with the proposed file sharing program, and thus, photos, files or data via My Event may be immediately exchanged therebetween, if they are invited to the event announced by the user of the portable device 33. Once the user of the portable devices 31, 32 or 33 add files to My Event or the users take photos, the files or photos will be immediately shared to the other portable devices that have joined the event. The file sharing mechanism is real-time and can be a multiple-to-multiple sharing mechanism. The shared files or photos are stored in the server 34 and the communication between the devices is implemented via wireless communication. In another embodiment, the portable devices 31, 32 and 33 can share the files or photos via the Bluetooth interface, and not via the server 34, if the portable devices 31, 32 and 33 can connect to each other via the Bluetooth interface. For example, the portable devices 31, 32 and 33 are in the same room and a wireless network is not available. Thus, the portable devices 31, 32 and 33 can share their data, files or photos via Bluetooth.

Furthermore, the portable device can connect to a projector to show the shared photos or files. My event can create a link to the projector via wired/wireless interface, and set the display configuration of the projector to display the shared photos or files.

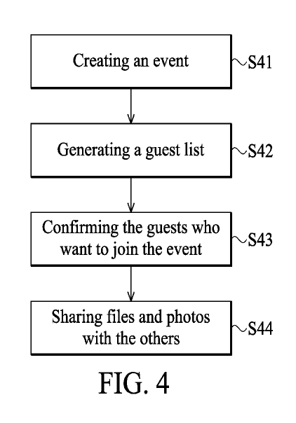

FIG. 4 is a flowchart of an embodiment of a file sharing method according to the invention. In step S41, a user first uses My Event to create an event. In step S42, the user can generate a guest list manually or via a positioning function. The operation of the positioning function has been described in the above paragraphs and is not described here for brevity. The event and the shared files or photos will be recorded and stored in the server of My Event. In another example, a user can use My Event to designate a website, a blog, a web album or other social network service to store the shared files or photos. For example, the user can designate an album folder of the user's facebook account, and all the shared photos will be uploaded to that folder. In step S43, the server of My Event will confirm the guests who want to join the event created by the user according to the guest list. Once gaining access following the confirmation procedure, the guest can share files and photos with the user and other guests via My Event.

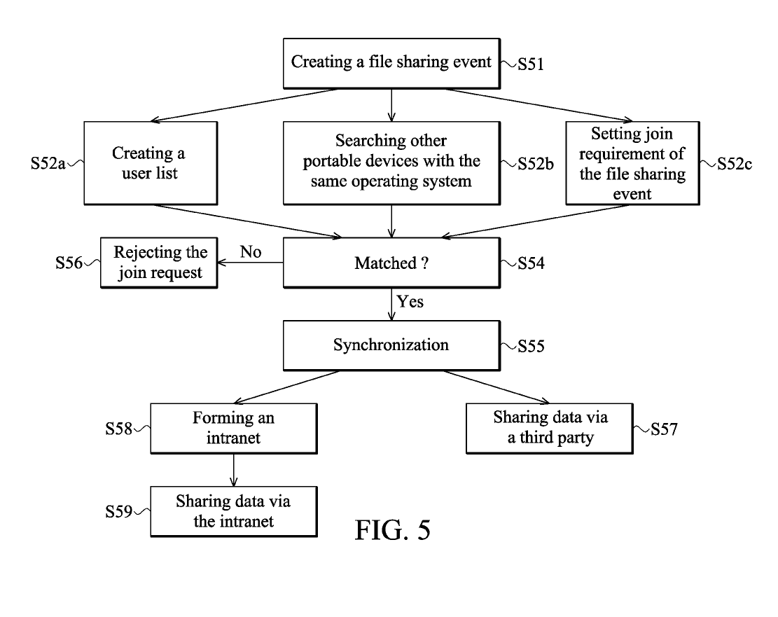

FIG. 5 is a flowchart of another embodiment of the file sharing embodiment according to the invention. In step S51, the first user of a first portable device creates a file sharing event via an application program installed in the first portable device. The application program can connect to a social network service provider that provides web storage space for file sharing. For example, the file sharing event connects to a web album, and all the pictures exchanged by the file sharing event will be uploaded to the web album. After step S51, the first user can invite other users to join the file sharing event by three ways. In this embodiment, the three ways shown in step S52a, S52c and S52c are merely examples for the invention, and the invention is not limited thereto.

In step S52a, the first user of the first portable device creates a user list that includes the users allowed to join the file sharing event. The user list comprises a user name (or other unique ID) and corresponding access right. In this embodiment, the user's name may be an account of the social network service which is linked to the file sharing event. For example, the user A has both the read right and write right to the folder that stores files, pictures or data when the file sharing event is being processed. Thus, the first user can upload and download the data to the folder. The second user only has a read right to the folder. Thus, the second user can only download the data, files or pictures from the folder. The user list can be generated by several ways. In one example, the first user can manually input the invited users' name. In another example, the user's name may be changed by the device name or device ID. The device ID is unique and cannot be changed, but the device name can be changed by a user.

In step S52b, the portable device that creates the file sharing event searches for other portable devices with the same operating system and invites the users having the portable devices that are being searched, to join the file sharing event. The following paragraph illustrates the step S52b with an example. First, the first portable device searches for portable devices having the same communication interface therewith via a network, internet or Bluetooth. Then, the first portable device determines whether the searched devices have the same operating system of the first portable device. If yes, the first portable device directly synchronizes with the searched portable device and invites the user of the searched portable device to join the file sharing event.

In step S52c, the first user sets a joining requirement of the file sharing event. For example, the user must have the invitation code to join the file sharing event. The invitation code may be in the form of QR code, bar code or 2D code. In another example, the first user creates a link that leads a user to a website to join the file sharing event. The described code and link may contain authentication information that require authentication by the social network service. The described code and link comprises the information of the file sharing event and a corresponding web link directed to a web album or an internet storage space.

The steps S52a, S52b and S52c show a confirmation procedure to confirm whether a portable device sending the joining request to join the file sharing event is authorized to join the file sharing event. In step S54, if the portable device is not authorized to join the file sharing event, the procedure goes to step S56 and the joining request from the portable device is rejected. If the portable device is accepted by the file sharing event, the procedure goes to step S55 and the first portable first synchronizes with the portable device or the portable device first synchronizes with a social network service server.

After step S55, the portable devices joining the file sharing event can share files, pictures or data. In this embodiment, there are two ways to share the data, files or pictures between portable devices. First, data sharing is implemented via a third party in step S57. For example, the file sharing event has the data, files or pictures directed to a social network service provider, such a web album. Therefore, all the portable devices joined to the file sharing event will all synchronize with the network service provider to get and download the latest data, files or pictures of the portable devices. Another way to share the data is implemented by the intranet. For example, an access point is configured for communications among the portable devices joining the file sharing event. Thus, in step S58, an intranet is formed for data sharing. The intranet may be implemented via an access point (AP) or Bluetooth technology. Then, in step S59, the portable devices can directly share data in the intranet by a peer to peer mechanism or multiple peers to peers mechanism.

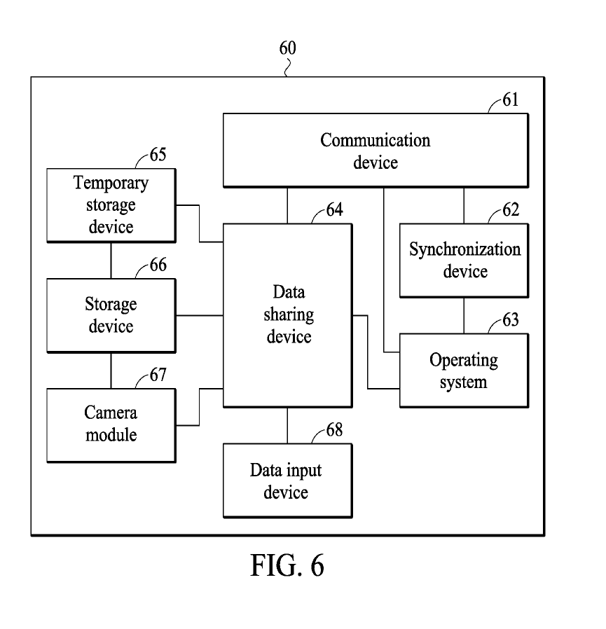

FIG. 6 is a block diagram of an embodiment of a portable device with the described file sharing mechanism according to the invention. The portable device 60 comprises a communication device 61, a synchronization device 62, an operating system 63, a data sharing device 64, a temporary storage device 65, a storage device 66, a camera module 67 and a data input device 68. The communication device 61 is a wireless module, WiMAX module, Bluetooth module or other wireless communication module. The synchronization device 62 synchronizes the portable device 60 with other portable devices or a social network service server. The data sharing device 64 can be implemented by software or hardware. The data sharing device 64 transmits data or files from the camera module 67 and the data input device 68 to other portable devices or a social network service server. The data input device 68 may be a drawing board that can share a drawing with other portable devices. The data input device 68 may be a database of the portable device 60, such as an album, and a user can select and share files directly from the database with other users. When photos are taken by the camera module 67, the photo will be immediately shared with other users joining the file sharing event. When the data sharing device 64 receives data from other portable devices, the data is first stored in the temporary storage device 65. Since the file sharing event may create a window on the display of the portable device 60, when a user drags one file from the window and drops the file of the desktop of the portable device 60, the file is then moved from the temporary storage device 65 and the stored in the storage device 66. The difference between the temporary storage device 65 and the storage device 66 is that the data stored in the temporary storage device 66 may be deleted when the portable device 60 is reset, turned off or the file sharing event is finished.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data sharing method for a portable device, comprising:
executing an application program to create a data sharing event by a first user; and
creating a user list by the first user,
wherein when a second user of the user list shares a first file via the data sharing event, the first user receives and stores the first file in the portable device.

2. The method as claimed in claim 1, wherein the data sharing event is connected to a social network service.

3. The method as claimed in claim 1, wherein the first file comprises user information of the second user.

4. The method as claimed in claim 2, wherein the step of creating the user list further comprises:
generating an invitation code corresponding to the data sharing event, wherein the invitation code is directed to a web link,
wherein when the social network service receives a request from a third portable device via the web link, a third user of the third portable device is added to the user list.

5. The method as claimed in claim 2, wherein the step of creating the user list further comprises:
searching for portable devices in a specific area via a communication device of a first portable device of the first user; and
when detecting that the application program is installed in a third portable device, adding the third portable device to the user list.

6. The method as claimed in claim 1, wherein the user list comprises a user name and an access right.

7. The method as claimed in claim 6, wherein the user name comprises a device ID of the portable device.

8. The method as claimed in claim 6, wherein the user name corresponds to an account of a social network service.

9. A data sharing method, comprising:
creating a data sharing event;
linking the data sharing event to a social network service;
generating a user list;
verifying and determining whether a first portable device is included in the user list;
allowing the first portable device to join the data sharing event when the first portable device is included in the user list and passes a verification procedure; and
when receiving a first file from the first portable device, uploading the first file to the social network service.

10. The method as claimed in claim 9, further comprising:
determining whether an application program corresponding to the data sharing event is installed in the first portable device; and
when application program corresponding to the data sharing event is not installed in the first portable device, preventing the first portable device from joining the data sharing event.

11. The method as claimed in claim 9, further comprising:
scanning portable devices in a specific area to determine whether an application program corresponding to the data sharing event is installed in the portable devices;
wherein an application program corresponding to the data sharing event is installed a second portable device, transmitting an invitation message to the second portable device; and
when receiving a confirm message from the second portable device, joining the second portable device to the data sharing event and updating the user list.

12. The method as claimed in claim 9, further comprising:
generating an invitation code corresponding to the data sharing event, wherein the invitation code is directed to a web link,
wherein when the social network service receives a request from a third portable device via the web link, a third user of the third portable device is added to the user list.

13. The method as claimed in claim 9, further comprising:
forming an intranet for only the portable devices on the user list,
wherein when the first portable device shares the first file, the first portable device directly transmits the first files to the potable devices on the user list via the intranet.

14. The method as claimed in claim 9, wherein the user list comprises a user name and an access right.

15. The method as claimed in claim 14, wherein the user name comprises a device ID of the portable device.

16. The method as claimed in claim 14, wherein the user name corresponds to an account of the social network service.
